(19) United States
(12) Patent Application Publication
(10) Pub. No.: US 2009/0236502 A1
(43) Pub. Date: Sep. 24, 2009

(54) OPTICAL RECEIVER UTILIZING APD AND CONTROL METHOD THEREOF

(75) Inventor: Toshio ISHII, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/409,943

(22) Filed: Mar. 24, 2009

(30) Foreign Application Priority Data
Mar. 24, 2008 (JP) 2008-076559
Mar. 16, 2009 (JP) 2009-062821

(51) Int. Cl. H01J 40/14

(52) U.S. Cl. 250/214 R

(57) ABSTRACT

An optical receiver includes an avalanche photodiode inputting light under a bias voltage, a current monitoring unit configured to monitor a photocurrent flowing through the avalanche diode, and a control unit configured to control the bias voltage. When the magnitude of the photocurrent exceeds a specific threshold, the control unit decreases the bias voltage, and when the magnitude of the photocurrent is less than or equal to the specific threshold, the control unit keeps the bias voltage constant.

The optical receiver may include a pre-amplifier disposed in series to the avalanche photodiode and configured to amplify the photocurrent. The specific threshold of the photocurrent corresponds to a dynamic range of the pre-amplifier.

### CROSS-REFERENCE TO RELATED APPLICATIONS

This application is based upon and claims the benefit of priority of the prior Japanese Patent Application No. 2008-076559, filed on Mar. 24, 2008, and Japanese Patent Application No. 2009-062821, filed on Mar. 16, 2009, the entire contents of which are incorporated herein by reference.

### FIELD

The present invention relates to controlling bias voltage applied to an avalanche photodiode (APD) which may be used for an optical receiver that uses an APD as a photoelectric transducer and controls voltage to be applied to the APD, an APD bias voltage controlling method, and an APD bias voltage controlling program.

### BACKGROUND

In optical transmission modules operating as receivers, devices having an optical receiver circuit including an APD as a photoelectric transducer are widely employed. One example of such devices is discussed in Japanese Unexamined Patent Application Publication No. 2000-244419. In a reception scheme using an APD, a pre-amplifier converts photocurrent to voltage and amplifies the voltage. Due to the lack of the dynamic range of the pre-amplifier, it is necessary to suppress photocurrent (Iapd) when optical input power (Pin) input to the APD is high. Exemplary techniques for suppressing photocurrent are discussed in Japanese Unexamined Patent Application Publication Nos. 2005-354548 and 2006-74214.

FIG. 14 is a diagram illustrating an optical receiver circuit using an APD according to the known art. The optical receiver circuit includes an APD 20, a self-bias resistor 30, a monitor unit 100, a voltage control unit 140, a pre-amplifier 150, and an identifying/reproducing unit 160. The monitor unit 100 includes a current monitor section 110 and a calculating section 130. In the optical receiver circuit illustrated in FIG. 14, the self-bias resistor 30 is connected in series to the APD 20. A voltage V0 at one end of the self-bias resistor 30 is controlled by the voltage control unit 140 to maintain a constant voltage. The photocurrent flowing through the APD 20 is converted to voltage and the voltage is amplified by the pre-amplifier 150. The amplified voltage is identified and reproduced by the identifying/reproducing unit 160 as data. The current flowing through the self-bias resistor 30 is monitored by the current monitor section 110, and optical input power is monitored by the calculating section 130. The configuration illustrated in FIG. 14 is discussed in, for example, Japanese Unexamined Patent Application Publication No. 2006-54507.

FIG. 15A is a graph illustrating the relationship of the voltage (V0) at one end of the self-bias resistor 30 and a bias voltage (Vapd) applied to the APD 20 with respect to the optical input power (Pin) input to the APD 20. FIG. 15B is a graph illustrating the relationship between the optical input power (Pin) and a multiplication factor (M) of the APD 20. FIG. 15C is a graph illustrating the relationship between the optical input power (Pin) and the photocurrent (Iapd) flowing through the APD 20. In FIG. 15C, Iapd is plotted using a log scale in the ordinate axis.

Referring back to FIG. 14, when Pin is high enough to increase the current flowing through the APD 20, as illustrated in FIG. 15A, the amount of voltage drop due to the self-bias resistor 30 increases, thereby reducing the bias voltage (Vapd) applied to the APD 20. Therefore, as illustrated in FIG. 15B, the multiplication factor (M) of the APD 20 decreases, and the photocurrent (Iapd) flowing through the APD 20 is suppressed to be less than or equal to 220 A, which is the current upper limit defined by the dynamic range of the pre-amplifier 150.

FIG. 16 is a graph illustrating the relationship (BER curve) of a bit error rate (BER) with respect to the optical input power (Pin) input to the APD 20 in the optical receiver circuit illustrated in FIG. 14. As illustrated in FIG. 15B, as the optical input power (Pin) input to the APD 20 increases, the multiplication factor (M) of the APD 20 gradually decreases. Thus, as illustrated in FIG. 15C, the tendency of the photocurrent (Iapd) flowing through the APD 20 to increase with respect to Pin is reduced. Accordingly, as illustrated in FIG. 16, the slope of the BER curve becomes less steep. As a result, when a signal-to-noise (SN) ratio is degraded due to a large amount of amplified spontaneous emission (ASE) from an optical amplifier included in incoming signal light, BER is degraded significantly when Pin is high. As a result, the dynamic range, which is the range of Pin satisfying a desired BER, becomes narrower, and the characteristics of the optical receiver circuit are degraded.

Even if Pin is low, M gradually decreases as Pin increases. Therefore, the high cut-off frequency of the APD 20 increases with a resultant increase in ASE beat noise variance, resulting in an increase in the number of noise components. The minimum value of BER at which reception can be performed is determined by noise limitation based on the optical signal-to-noise ratio (OSNR). When Pin is high, the endurance of the optical receiver circuit relative to the OSNR degradation is significantly deteriorated.

In Telcordia GR253, which is the SONET standard specification, the jitter tolerance of the category II receiver is measured by a “1-dB Power Penalty Method”. This method measures the jitter tolerance by using Pin with a certain BER. This Pin is increased by 1 dB, and then jitter is applied to find the maximum amplitude of jitter that causes the same (but not greater) BER as the original Pin that existed before the increase.

As illustrated in FIG. 16, in the optical receiver circuit illustrated in FIG. 14, the jitter tolerance measured by the “1-dB Power Penalty Method” is degraded since the slope of the BER curve is small.

### SUMMARY

An optical receiver includes an avalanche photodiode inputting light under a bias voltage, a current monitoring unit configured to monitor a photocurrent flowing through the avalanche diode, and a control unit configured to control the bias voltage. When the magnitude of the photocurrent exceeds a specific threshold, the control unit decreases the bias voltage, and when the magnitude of the photocurrent is less than or equal to the specific threshold, the control unit keeps the bias voltage constant.

The optical receiver may include a pre-amplifier disposed in series to the avalanche photodiode and configured to amplify the photocurrent. The specific threshold of the photocurrent corresponds to a dynamic range of the pre-amplifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an optical receiver according to an embodiment;

FIG. 2 is a diagram illustrating the operation of a monitor unit;

FIG. 3A is a graph illustrating a change in Iapd with respect to Pin;

FIG. 3B is a graph illustrating a change in Vapd with respect to Pin.

FIG. 3C is a graph illustrating the result of monitoring Pin when Iapd is less than or equal to an upper limit;

FIG. 3D is a graph illustrating the result of monitoring Pin when Iapd exceeds the upper limit;

FIG. 3E is a diagram combining calculation results obtained in FIGS. 3C and 3D;

FIG. 4A is a graph illustrating the relationship of a voltage (V0) at one end of a monitor resistor and a bias voltage (Vapd) applied to an APD with respect to optical input power input to the APD;

FIG. 4B is a graph illustrating the relationship between the optical input power (Pin) and a multiplication factor (M) of the APD;

FIG. 4C is a graph illustrating the relationship between the optical input power (Pin) and the photocurrent (Iapd) flowing through the APD;

FIG. 5 is a graph illustrating a change in M with respect to a change in Pin in the optical receiver of the present embodiment (FIG. 4B) in contrast to that in an optical receiver of the known art (FIG. 15B);

FIG. 6 is a flowchart illustrating a processing operation of the optical receiver according to the embodiment;

FIG. 7 is a graph illustrating a change in Iapd with respect to a change in Pin in the optical receiver of the present embodiment (FIG. 4C) in contrast to that in the optical receiver of the known art (FIG. 15C);

FIG. 8 is a graph illustrating a BER curve obtained by plotting a BER relative to Pin with no OSNR degradation, which is illustrated relative to a configuration of the known art denoted by a dotted line and a configuration of the present embodiment denoted by a solid line;

FIG. 9 is a graph illustrating a BER curve with a low OSNR, which is illustrated relative to the configuration of the known art denoted by a dotted line and the configuration of the present embodiment denoted by a solid line;

FIG. 10 is a graph illustrating signal amplitude and noise variance with a low OSNR, with respect to Pin;

FIG. 11 is a graph illustrating a BER curve in the present embodiment, which is denoted by a solid line, and a BER curve of the known art, which is denoted by a dotted line, in association with jitter tolerance measurement;

FIG. 12 is a graph illustrating an eye opening at the time the jitter tolerance is measured;

FIG. 13 is a graph illustrating the jitter tolerance at high frequencies;

FIG. 14 is a diagram illustrating an optical receiver circuit using an APD according to the known art;

FIG. 15A is a graph illustrating the relationship of a voltage (V0) at one end of a monitor resistor and a bias voltage (Vapd) applied to an APD of the known art with respect to optical input power (Pin) input to the APD;

FIG. 15B is a graph illustrating the relationship between the optical input power (Pin) and a multiplication factor (M) of the APD of the known art;

FIG. 15C is a graph illustrating the relationship between the optical input power (Pin) and the photocurrent (Iapd) flowing through the APD of the known art; and

FIG. 16 is a graph illustrating the relationship (BER curve) of a BER relative to the optical input power (Pin) input to the APD in the optical receiver circuit illustrated in FIG. 14 of the known art.

### DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

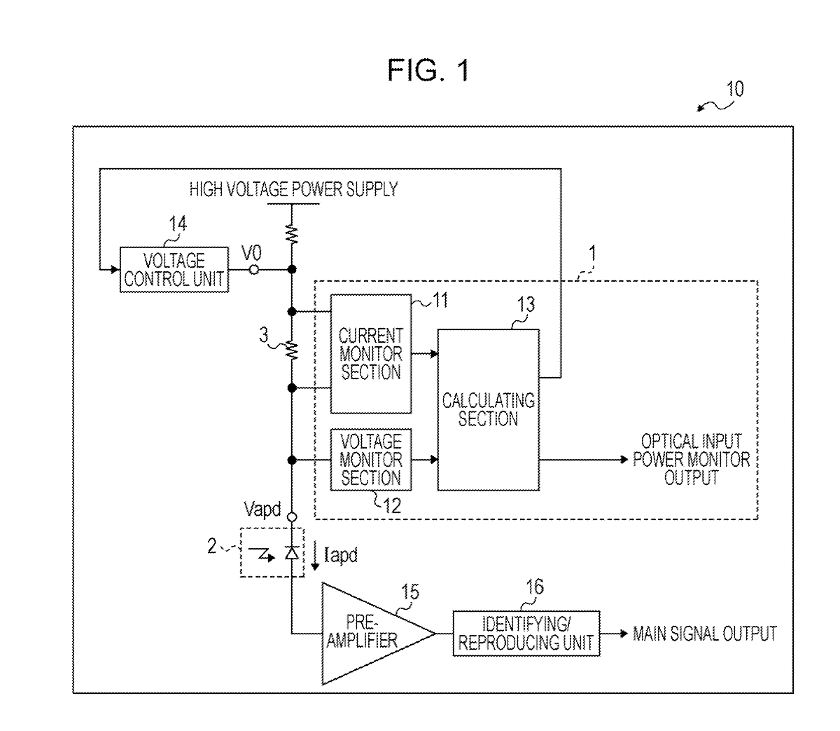

FIG. 1 is a diagram illustrating an optical receiver according to an embodiment. Referring to FIG. 1, an optical receiver 10 includes a monitor unit 1, an APD 2, a monitor resistor 3, a voltage control unit 14, a pre-amplifier 15, and an identifying/reproducing unit 16. The monitor unit 1 includes a current monitor section 11, a voltage monitor section 12, and a calculating section 13.

With continued reference to FIG. 1, the monitor resistor 3 is connected in series to the APD 2. A voltage V0 at one end of the monitor resistor 3 is controlled by the voltage control unit 14. The photocurrent flowing through the APD 2 is input to the pre-amplifier 15, which converts the photocurrent into a voltage signal, amplifies the voltage thereof, and outputs the amplified voltage signal to the identifying/reproducing unit 16. The pre-amplifier 15 has a dynamic range serving as a permitted current upper limit. When the current exceeds this current upper limit, saturation occurs, and accordingly, an error occurs. The identifying/reproducing unit 16 shapes the waveform of the voltage signal amplified by the pre-amplifier 15, performs re-timing and re-identification of the shaped voltage signal, and then outputs an electric signal.

The current monitor section 11 monitors Iapd, which is the photocurrent flowing through the APD 2, and sends an Iapd monitor value as a monitoring result to the calculating section 13. The voltage monitor section 12 monitors Vapd, which is a bias voltage applied to the APD 2, and sends a Vapd monitor value as a monitoring result to the calculating section 13.

The calculating section 13 determines whether the magnitude of the monitored Iapd is greater than a specific threshold. Specifically, the calculating section 13 determines whether the Iapd monitor value sent from the current monitor section 11 is greater than a preset Iapd upper limit. When it is determined that the Iapd monitor value is greater than the Iapd upper limit, the calculating section 13 sends a notification to the voltage control unit 14 to control the voltage V0 so that Vapd decreases and Iapd becomes constant without exceeding the dynamic range. In contrast, when it is determined that the magnitude of Iapd is less than or equal to the specific threshold, the calculating section 13 sends a notification to the voltage control unit 14 to control the voltage V0 so that Vapd is maintained at a high level.

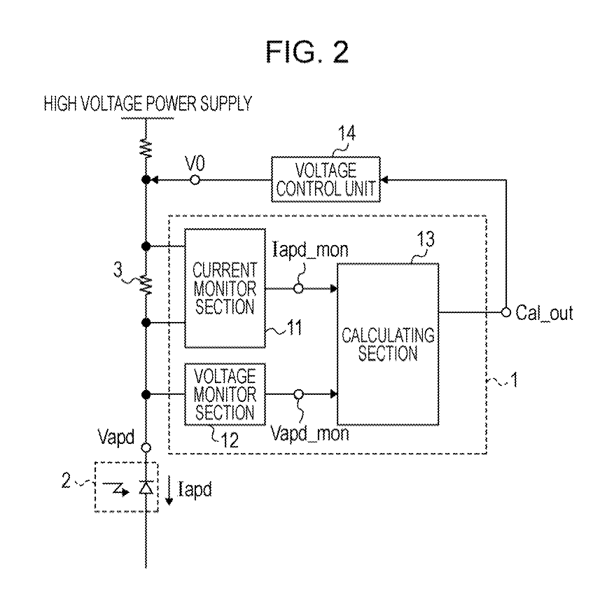

FIG. 2 is a diagram illustrating the operation of the monitor unit 1. As illustrated in FIG. 2, the calculating section 13 reads an Iapd monitor value (Iapd_mon) and a Vapd monitor value (Vapd_mon) from the current monitor section 11 and the voltage monitor section 12, respectively. Next, the calculating section 13 determines whether the Iapd monitor value (Iapd_mon) is greater than an Iapd upper limit (Ilim) that is set to a value slightly lower than an upper limit permitted by the dynamic range of the pre-amplifier 15 (hereinafter called “dynamic range”).

When the Iapd monitor value (Iapd_mon) exceeds the Iapd upper limit (Ilim), which is set to a value slightly lower than the dynamic range, the calculating section 13 calculates, in order to control Iapd to maintain a constant level, the difference (“ΔCal_out(1)”) between an output before the calculation (Cal_out(t0)) and an output after the calculation (Cal_out(t1)).

Given a breakdown voltage VB(V) of the APD 2, if a multiplication factor of the APD 2 is Mref(1) and a bias voltage applied to the APD 2 is Vapd_ref(1) when Iapd is the Iapd upper limit (Ilim), the target multiplication factor of the APD 2 (Mref(1)) and the target bias voltage (Vapd_ref(1)) are calculated by the following equations, where n denotes a fitting coefficient:

$$\begin{matrix}{M}_{ref} ( 1 ) = \frac{{I}_{lim}}{{I}_{apd \_ mon} \times \{ 1 - {( \frac{{V}_{apd \_ mon}}{VB} )}^{n} \}} & ( 1 ) \\ {V}_{apd \_ ref} ( 1 ) = \frac{\sqrt[n]{1 - \frac{1}{{M}_{ref} ( 1 )}}}{VB} & ( 2 )\end{matrix}$$

In the case where the voltage control unit 14 performs G-times amplification, when the resistance of the monitor resistor 3 is Rrefbias, ΔCal_out(1) can be obtained by the following equation:

$$Δ Cal \_ out ( 1 ) = \frac{1}{G} \times \{ \begin{matrix}{V}_{apd \_ mon} - {V}_{apd \_ mon} ( 1 ) + \\ ( {I}_{apd \_ mon} - {I}_{lim} ) \times {R}_{selfbias}\end{matrix} \} \qquad ( 3 )$$

Accordingly, the calculated difference ΔCal_out(1) and the output before the calculation (Cal_out(t0)) are added to obtain the output after the calculation (Cal_out(t1)), which is sent to the voltage control unit 14, whereby the voltage V0 is controlled.

Next, when the Iapd monitor value (Iapd_mon) does not exceed the Iapd upper limit (Ilim), the calculating section 13 controls Vapd to maintain a constant level. It is determined whether a difference obtained by subtracting a Vapd control target value (Vapd_ref(2)) at the time of controlling Vapd to maintain a constant level from the Vapd monitor value (Vapd_mon) is “0”.

When the difference obtained by subtracting the Vapd control target value (Vapd_ref(2)) from the Vapd monitor value (Vapd_mon) is “0”, the calculating section 13 calculates the difference (“ΔCal_out”) between the output before the calculation (Cal_out(t0)) and the output after the calculation (Cal_out(t1)) as “0”. That is, a value equivalent to the output before the calculation (Cal_out(t0)) is output as the output after the calculation (Cal_out(t1)).

In contrast, when the difference obtained by subtracting the Vapd control target value (Vapd_ref(2)) from the Vapd monitor value (Vapd_mon) is not “0”, the calculating section 13 calculates the difference (“ΔCal_out(2)”) between the output before the calculation (Cal_out(t0)) and the output after the calculation (Cal_out(t1)).

The multiplication factor of the APD 2 before the calculation (M(t0)) is obtained by the following equation:

$$M ( t 0 ) = \frac{1}{1 - {( \frac{{V}_{apd \_ mon}}{VB} )}^{n}} \qquad ( 4 )$$

Using the multiplication factor (Mref(2)) of the APD 2 in the case of the Vapd control target value (Vapd_ref(2)), ΔCal_out(2) can be obtained by the following equation:

$$Δ Cal \_ out ( 2 ) = \frac{1}{G} \times \{ \begin{matrix}{V}_{apd \_ mon} - {V}_{apd \_ ref} ( 2 ) + \\ ( 1 + \frac{{M}_{ref} ( 2 )}{M ( t 0 )} ) \times {I}_{apd \_ mon} \times {R}_{selfbias}\end{matrix} \} \qquad ( 5 )$$

When the Iapd monitor value (Iapd_mon) either exceeds the Iapd upper limit (Ilim) or is less than or equal to the Iapd upper limit (Ilim), the calculating section 13 adds the calculated difference ΔCal_out and the output before the calculation (Cal_out(t0)) to obtain the output after the calculation (Cal_out(t1)).

The voltage control unit 14 controls the voltage V0 on the basis of the output of the calculating section 13. That is, when it is determined that the magnitude of Iapd is greater than the specific threshold, the voltage control unit 14 controls the voltage V0 so that Vapd decreases. When it is determined that the magnitude of Iapd is less than or equal to the specific threshold, the voltage control unit 14 controls the voltage V0 so that Vapd is maintained at a constant high level. Upon receipt of a notification from the calculating section 13 indicating that the voltage V0 should be controlled so as to reduce Vapd, the voltage control unit 14 controls the voltage V0 so as to reduce Vapd and to maintain Iapd at a constant level within the dynamic range. In contrast, upon receipt of a notification indicating that the voltage V0 should be controlled so as to maintain Vapd at a constant high level, the voltage control unit 14 controls the voltage V0 so as to maintain Vapd at a constant high level.

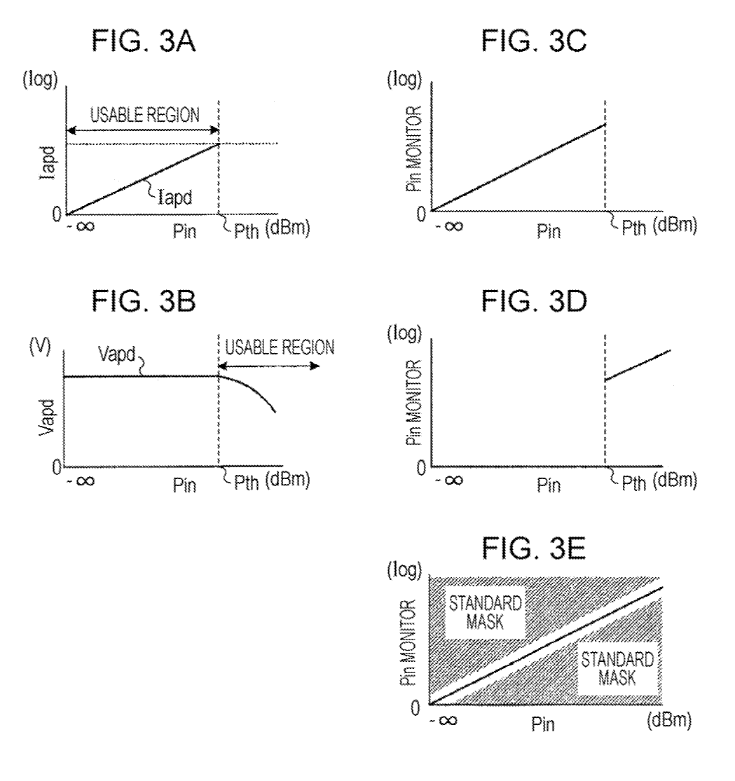

Since the calculating section 13 changes the control method between the case in which the Iapd monitor value (Iapd_mon) exceeds the Iapd upper limit (Ilim) and the case in which the Iapd monitor value (Iapd_mon) is less than or equal to the Iapd upper limit (Ilim), the optical input power (Pin) cannot be obtained directly from the Iapd values relative to all levels of Pin. FIGS. 3A through 3E are diagrams illustrating a process of calculating a monitor value of the optical input power (Pin) from Iapd and Vapd. FIG. 3A is a diagram illustrating a change in Iapd with respect to Pin. FIG. 3B is a diagram illustrating a change in Vapd with respect to Pin. FIG. 3C is a diagram illustrating the result of monitoring Pin when Iapd is less than or equal to the upper limit. FIG. 3D is a diagram illustrating the result of monitoring Pin when Iapd exceeds the upper limit. FIG. 3E is a diagram combining calculation results obtained in FIGS. 3C and 3D.

When Iapd is less than or equal to the Iapd upper limit, the calculating section 13 performs control so that Vapd becomes constant, as illustrated in FIG. 3B. Therefore, a Pin monitor value can be obtained by performing an operation on the Iapd monitor value. In contrast, when Iapd is greater than the Iapd upper limit, as illustrated in FIG. 3A, the calculating section 13 performs control so that Iapd becomes constant. Therefore, a Pin monitor value can be obtained by performing an operation on the Vapd monitor value.

When Iapd is less than or equal to the Iapd upper limit, Iapd is proportional to Pin in the following manner:

$${I}_{apd} = \frac{e \times λ}{ℏ \times c} \times η \times M \times Pin \\ e \text{:} elementary charge , \\ λ \text{:} wavelength , \\ h \text{:} Planck ' s constant , \\ c \text{:} speed of light , \\ η \text{:} quantum efficiency of A P D \qquad ( 6 )$$

Thus, if M is constant, the Pin monitor output is expressed as the following equation:

$$Pin monitor value = \frac{{I}_{apd \_ mon}}{R \times M} \times k , \\ R = \frac{e \times λ}{ℏ \times c} \times η \qquad ( 7 )$$

where k is a coefficient for fitting the slope or interface.

In contrast, when Iapd is greater than the Iapd upper limit, as described above, the calculating section 13 performs control so that Iapd becomes constant. Therefore, a Pin monitor value can be obtained by performing an operation on the Vapd monitor value. First, M can be obtained by the following equation, given the fitting coefficient n:

$$M = \frac{1}{1 - {( \frac{{V}_{apd}}{{V}_{B}} )}^{n}} \qquad ( 8 )$$

Since Iapd is controlled on the basis of the upper limit (Ilim), the Pin monitor value can be expressed as the following equation, where k is a coefficient for fitting the slope or interface:

$$Pin monitor value = \frac{( {I}_{lim} ) \times \{ 1 - {( \frac{{V}_{apd\_mon}}{{V}_{B}} )}^{n} \}}{R} \times k \qquad ( 9 )$$

That is, in the case of the optical input power (Pin) with which Iapd is greater than the Iapd upper limit, Iapd is controlled to maintain a constant level. In this Pin region, Iapd cannot be used for monitoring Pin. Therefore, in the region where Iapd is constant, Vapd is monitored, an operation is performed on the Vapd monitor value, and the result thereof is output.

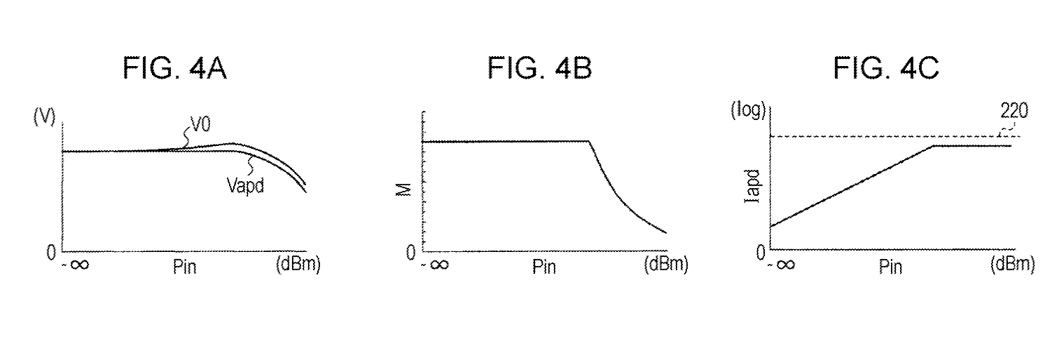

FIG. 4A is a graph illustrating the relationship of the voltage (V0) at one end of the monitor resistor 3 and the bias voltage (Vapd) applied to the APD 2 with respect to the optical input power (Pin) input to the APD 2. FIG. 4B is a graph illustrating the relationship between the optical input power (Pin) and the multiplication factor (M) of the APD 2. FIG. 4C is a graph illustrating the relationship between the optical input power (Pin) and the photocurrent (Iapd) flowing through the APD 2. In FIG. 4C, Iapd is plotted using log scale in ordinate. As illustrated in FIG. 4A, when the magnitude of Iapd is determined to be less than or equal to the specific threshold, the voltage control unit 14 controls the voltage V0 so as to maintain Vapd at a constant high level. When Pin is high, the voltage control unit 14 controls the voltage V0 so as to reduce Vapd. In accordance with these changes in Vapd, as illustrated in FIG. 4B, when Pin is within the range of the Iapd upper limit, M is maintained at a relatively high value. When Pin is high, M decreases. As illustrated in FIG. 4C, since M is reduced, Iapd satisfies the dynamic range (permitted current upper limit) of the pre-amplifier 15.

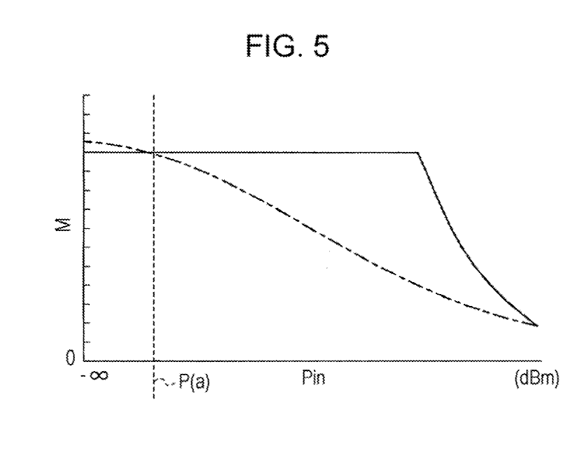

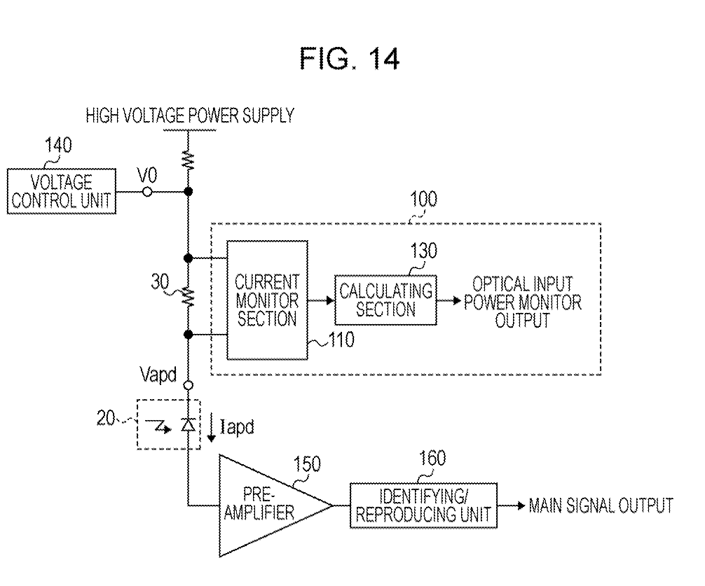

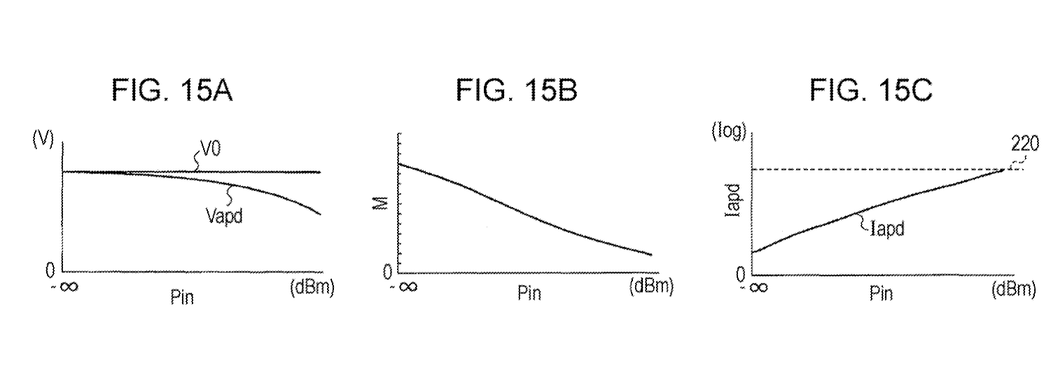

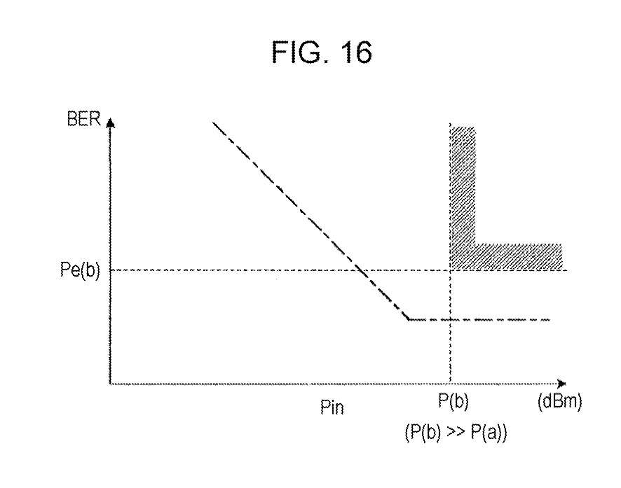

FIG. 5 is a graph illustrating a change in M relative to a change in Pin in the optical receiver of the present embodiment (FIG. 4B) in contrast to that in an optical receiver of the known art (FIG. 15B). A solid line denotes a change in M in the optical receiver of the present embodiment, and a dotted line denotes a change in M in the optical receiver of the known art. As illustrated in FIG. 5, when Pin is higher than P(a) that is Pin with which M is optimized for the minimum reception sensitivity, M can almost always be set to a constant value higher than that in the configuration of the known art illustrated in FIGS. 14 and 15A to 15C, over a longer range than is achieved in the known art. An increase in circuit dimensions can be suppressed by employing, for the current monitor section 11 and the calculating section 13 described above, a configuration within the optical input power monitoring function even included in the configuration of the known art.

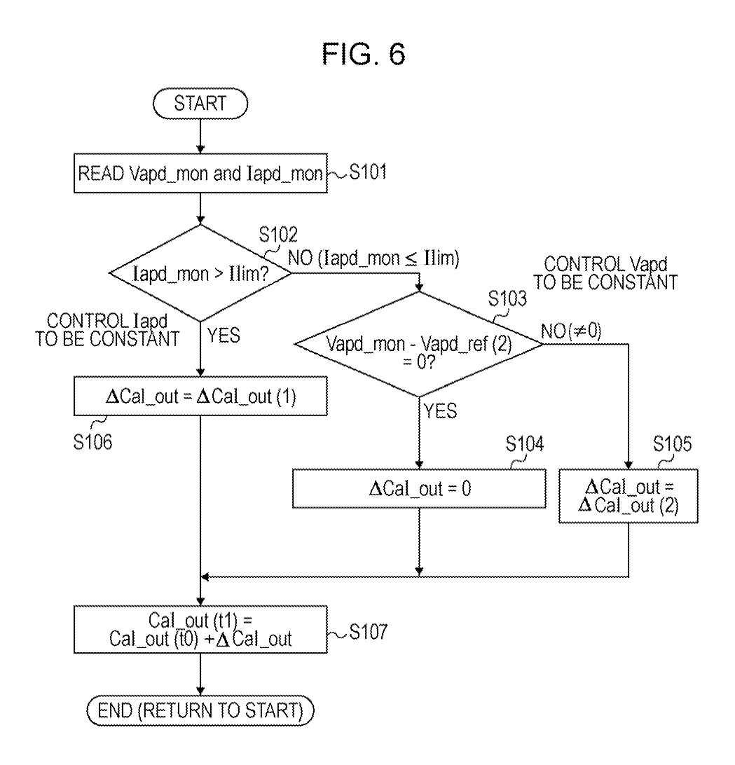

FIG. 6 is a flowchart illustrating a processing operation of the optical receiver 10 according to the embodiment. As illustrated in FIG. 6, the calculating section 13 of the optical receiver 10 reads an Iapd monitor value (Iapd_mon) and a Vapd monitor value (Vapd_mon) from the current monitor section 11 and the voltage monitor section 12, respectively (step S101). The calculating section 13 determines whether or not the Iapd monitor value (Iapd_mon) is greater than the Iapd upper limit (Ilim), which is set to a value slightly lower than the dynamic range (step S102).

As a result, when the Iapd monitor value (Iapd_mon) exceeds the Iapd upper limit (Ilim), which is set to a value slightly lower than the dynamic range (“YES” in step S102), the calculating section 13 calculates, in order to control Iapd so that Iapd becomes constant, the difference (“ΔCal_out(1)”) between the output before the calculation (Cal_out(t0)) and the output after the calculation (Cal_out(t1)) (step S106).

In contrast, when the Iapd monitor value (Iapd_mon) is less than or equal to the Iapd upper limit (Ilim) (“NO” in step S102), in order to control Vapd so that Vapd becomes constant, the calculating section 13 determines whether or not the difference obtained by subtracting the Vapd control target value (Vapd_ref(2)) at the time of controlling Vapd to maintain a constant level from the Vapd monitor value (Vapd_mon) is “0” (step S103).

As a result, when the difference is “0” (“YES” in step S103), the calculating section 13 calculates the difference (“ΔCal_out”) between the output before the calculation (Cal_out(t0)) and the output after the calculation (Cal_out(t1)) as “0” (step S104). In contrast, when the difference is not “0” (“NO” in step S103), the calculating section 13 calculates the difference (“ΔCal_out(2)”) between the output before the calculation (Cal_out(t0)) and the output after the calculation (Cal_out(t1)) (step S105).

The calculating section 13 adds the calculated difference ΔCal_out and the output before the calculation (Cal_out(t0)) to obtain, as a calculation result, the output after the calculation (Cal_out(t1)) (step S107), and sends the calculation result to the voltage control unit 14. Thereafter, the voltage control unit 14 controls the voltage V0 on the basis of the calculation result (Cal_out(t1)).

As has been described above, when the photocurrent is small, the optical receiver 10 which is an optical receiving module in which the monitor resistor 3 is connected in series to the APD 2 maintains the APD bias voltage at a constant high level. When the photocurrent is large, the optical receiver 10 reduces the APD bias voltage. As a result, the OSNR endurance when Pin is high can be improved. Furthermore, the jitter tolerance measured by the “1-dB Power Penalty Method” can be improved.

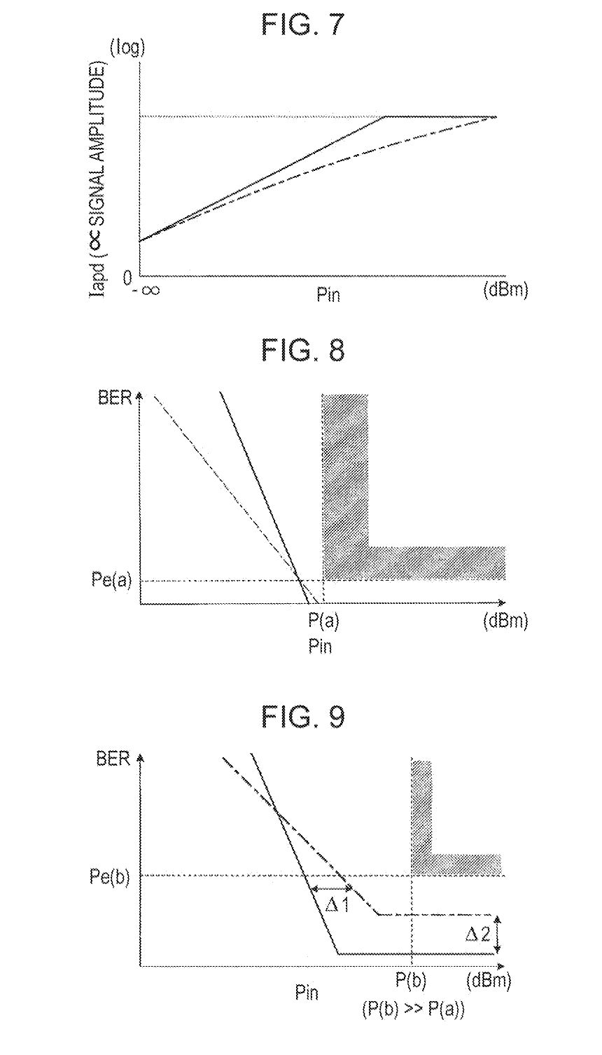

FIG. 7 is a graph illustrating a change in Iapd relative to a change in Pin in the optical receiver of the present embodiment (FIG. 4C) in contrast to that in the optical receiver of the known art (FIG. 15C). A solid line denotes a change in Iapd in the optical receiver of the present embodiment, and a dotted line denotes a change in Iapd in the optical receiver of the known art. Relative to Iapd, which is a direct current component, the amplitude (Ipp) of a reception signal can be expressed as:

Ipp≅2×k×Iapd (10)

As illustrated in FIG. 7, in the configuration of the known art denoted by a dotted line, as M gradually becomes smaller, an increase in the amplitude involved in an increase in Pin is cancelled out, and the slope becomes less steep. In contrast, in the optical receiver 10 of the present embodiment, which is denoted by a solid line, as illustrated in FIG. 4B and FIG. 5, when Pin is small, M is fixed. Therefore, the slope becomes steeper than that in the configuration of the known art.

FIG. 8 is a graph illustrating a BER plotted relative to Pin with no OSNR degradation, which is illustrated relative to the configuration of the known art denoted by a dotted line and the configuration of the present embodiment denoted by a solid line. In the configuration of the known art, an increase in slope of Iapd relative to Pin is small. Thus, the slope of the BER curve is small. In contrast, in the configuration of the present embodiment, as illustrated in FIG. 7, an increase in slope of Iapd relative to Pin is large. Thus, the slope of the BER curve is larger than that in the configuration of the known art. In general, M is adjusted to be optimal at a BER level according to the standard. Under the minimum reception sensitivity conditions (the minimum value of Pin satisfying the BER according to the standard, which is a relatively general specification), there are no characteristic differences between the configuration of the known art and the configuration of the present embodiment.

FIG. 9 is a graph illustrating a BER curve with a low OSNR, which is illustrated relative to the configuration of the known art denoted by a dotted line and the configuration of the present embodiment denoted by a solid line. As the SN ratio of an input signal becomes degraded due to ASE, the BER curve is shifted to be higher than that with no OSNR degradation, which is shown in FIG. 8. At this time, two specifications, i.e., the minimum reception sensitivity with no OSNR degradation and the dynamic range with OSNR degradation (Pin range satisfying a desired BER), are established. When M has been adjusted at a BER level according to the minimum reception standard, the BERs are reversed at or over Pin with which M has been optimized due to the difference between the slopes of the BER curves in the configuration of the present embodiment and the configuration of the known art. As a result, the BER in the configuration of the present embodiment becomes better than that in the configuration of the known art. As indicated by Δ1 in FIG. 9, the dynamic range in the configuration of the present embodiment becomes wider than that in the configuration of the known art.

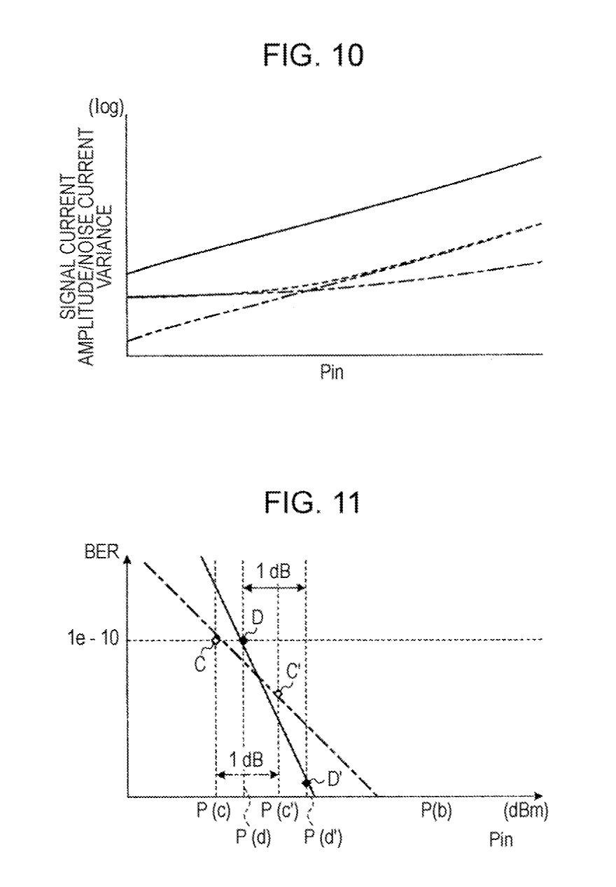

FIG. 10 is a graph illustrating signal amplitude and noise variance with a low OSNR, with respect to Pin. Referring to FIG. 10, a solid line denotes signal amplitude; a one-dot chain line denotes noise variance of OSNR; a two-dot chain line denotes other noise variance; and a dotted line denotes full noise variance. In a high input power region, the SN ratio due to noise components other than OSNR is improved because of an increase in the signal amplitude. Thus, noise components of OSNR become dominant, and the minimum value of BER is determined by the SN ratio with respect to the noise components of OSNR.

The ASE beat noise variance (σb), and the high cut-off frequency (B) of an APD are expressed by the following equations:

$${σ}_{b} = \sqrt{{I}_{b}^{2} \times B ,} \\ B = \frac{GB Product}{M} \qquad ( 11 )$$

where Ib is a frequency differential component of noise current.

Regarding the minimum value of BER determined by noise limitation based on the OSNR, in the configuration of the known art, as shown in FIG. 5 and FIG. 15B, since M is reduced, the high cut-off frequency (B) of the APD increases, resulting in an increase in the ASE beat noise variance (σb). In contrast, in the configuration of the present embodiment, as illustrated in FIG. 5 and FIG. 4B, since M is constant, there is no increase in the ASE beat noise variance (σb) due to an increase in the high cut-off frequency (B). As a result, as indicated by Δ2 in FIG. 9, the minimum value of BER of the configuration of the present embodiment becomes smaller. In this way, the OSNR endurance when Pin is high is improved.

In Telcordia GR253, which is the standard specification, the jitter tolerance of the category II receiver is determined by using Pin with a certain BER. This Pin is increased by 1 dB, and then jitter is applied to find the maximum amplitude of jitter that causes the same (but not greater) BER as the original Pin that existed before the increase.

FIG. 11 is a graph illustrating a BER curve in the present embodiment, which is denoted by a solid line, and a BER curve in the known art, which is denoted by a dotted line, in association with jitter tolerance measurement. As illustrated in FIG. 11, when measurements are performed on the basis of BER=1e−10 in the vicinity of the minimum reception, in the configuration of the known art, the jitter tolerance is measured at P(c′), which is obtained by increasing Pin by 1 dB from that at point C (Pin=P(c)) where BER=1e−10. In contrast, in the configuration of the present embodiment, similarly, the jitter tolerance is measured at P(d′). As a result, the BER at the time the jitter tolerance is measured in the configuration of the present embodiment (point D′) becomes lower than the BER at the time the jitter tolerance is measured in the configuration of the known art (point C′).

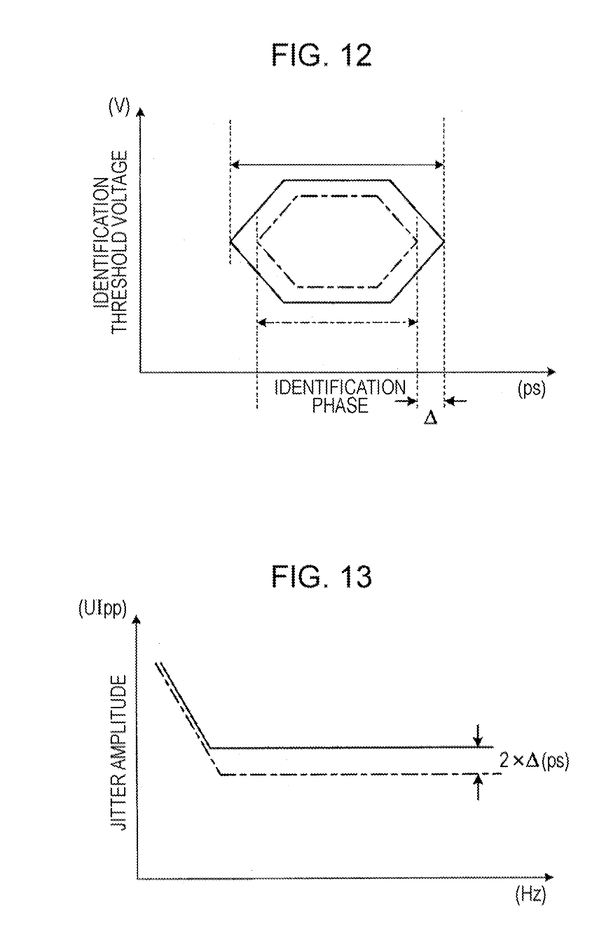

FIG. 12 is a graph illustrating an eye opening at the time the jitter tolerance is measured. In this graph, identification phase is plotted in abscissa, and identification threshold voltage is plotted in ordinate. A dotted line denotes an eye opening in the configuration of the known art, and a solid line denotes an eye opening in the configuration of the present embodiment. Referring to FIG. 12, due to the difference in BER between point C′ and point D′, the eye opening at the time the jitter tolerance is measured in the configuration of the known art is relatively small. In contrast, the eye opening at the time the jitter tolerance is measured in the configuration of the present embodiment is relatively large. As a result, the opening width in the phase direction is wider by Δ in the configuration of the present embodiment than that in the configuration of the known art.

FIG. 13 is a graph illustrating the jitter tolerance at high frequencies. In this graph, frequency is plotted in abscissa, and the jitter amplitude is plotted in ordinate. A dotted line denotes tolerance characteristics of the configuration of the known art, and a solid line denotes tolerance characteristics of the configuration of the present embodiment. As illustrated in FIG. 13, in a high-frequency region where a phase lock loop (PLL) performs no tracking, the jitter tolerance is susceptible to the eye opening width in the phase direction. As illustrated in FIG. 12, since the opening width in the phase direction of the eye opening at the time the jitter tolerance is measured in the configuration of the known art is relatively small, the jitter tolerance becomes small in the frequency region where the PLL performs no tracking. In contrast, at the time the jitter tolerance is measured in the configuration of the present embodiment, the opening width in the phase direction is relatively large. Thus, the jitter tolerance becomes large in the frequency region where the PLL performs no tracking. As illustrated in FIG. 13, a difference in jitter tolerance is substantially equivalent to twice Δ illustrated in FIG. 12. From these points, the jitter tolerance measured by the “1-dB Power Penalty Method” can be improved.

Since it is determined whether or not the magnitude of the monitored Iapd exceeds the specific threshold, which is set to a value slightly lower than the dynamic range of the pre-amplifier, Iapd can be increased to a value near the dynamic range of the pre-amplifier, but not greater than the dynamic range of the pre-amplifier, and then Iapd can be controlled to maintain a constant level.

When Iapd is less than or equal to the Iapd upper limit, Iapd is monitored, and, based on the Iapd monitor value, the result of monitoring Pin is output. When Iapd is greater than the Iapd upper limit, the result of monitoring Pin is output based on Vapd. Therefore, even after Iapd becomes constant, the Pin monitor result can be appropriately output.

The present invention can be implemented in various different embodiments other than the above-described embodiment.

Also, in the individual processes described in the present embodiment, all or some of the processes described as being automatically performed may be manually performed. Alternatively, all or some of the processes described as being manually performed may be automatically performed using a method of the known art. Furthermore, unless otherwise specified, changes can be arbitrarily made to the processing procedures, control procedures, specific names, and information including various items of data and parameters described in the foregoing description and/or illustrated in the drawings.

The components of the individual devices illustrated in the drawings are functionally conceptual components and are not necessarily configured as physical components as illustrated in the drawings. That is, specific forms of distribution and integration of the individual devices are not limited to those illustrated in the drawings. All or some of the individual devices may be configured by being functionally or physically distributed/integrated, in arbitrary units, in accordance with various loads and usage situations. Furthermore, all or some of the processing functions performed by the individual devices may be implemented by a central processing unit (CPU) and a program analyzed and executed by the CPU, or may be implemented as wired-logic hardware.

The APD bias voltage controlling method described in the present embodiment may be realized by executing or using a computer such as a personal computer or a workstation, a program prepared in advance. The program may be distributed via a network, such as the Internet. Alternatively, the program may be recorded on a computer-readable recording medium, such as a hard disk, a flexible disk (FD), a compact-disc read-only memory (CD-ROM), a magneto-optical disc (MO), or a digital versatile disc (DVD), and may be read from the recording medium using a computer, whereby the program is executed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical receiver, comprising:
an avalanche photodiode inputting light under a bias voltage;
a current monitoring unit configured to monitor a photocurrent flowing through the avalanche diode; and
a control unit configured to control the bias voltage, wherein,
when the magnitude of the photocurrent exceeds a specific threshold, the control unit decreases the bias voltage, and
when the magnitude of the photocurrent is less than or equal to the specific threshold, the control unit keeps the bias voltage constant.

2. The optical receiver according to claim 1, further comprising a pre-amplifier disposed in series to the avalanche photodiode and configured to amplify the photocurrent, wherein
the specific threshold of the photocurrent corresponds to a dynamic range of the pre-amplifier.

3. The optical receiver according to claim 1, further comprising:
a voltage monitoring unit configured to monitor the bias voltage; and
an input light power monitoring unit configured to calculate an optical input power monitor value of the avalanche photodiode, wherein,
when the photocurrent exceeds the specific threshold, the input light power monitoring unit calculates the optical input power monitor value based on the bias voltage monitored by the voltage monitoring unit, and,
when the photocurrent is less than or equal to the specific threshold, the input light power monitoring unit calculates the optical input power monitor value based on the magnitude of the photocurrent monitored by the current monitoring unit.

4. An avalanche photodiode bias voltage controlling method for controlling, in an optical receiver using an avalanche photodiode, an avalanche photodiode bias voltage to be applied to the avalanche photodiode, comprising:
a current monitoring step of monitoring a magnitude of photocurrent;
a determining step of determining whether the magnitude of the photocurrent monitored in the current monitoring step exceeds a specific threshold; and
a control step of performing, when it is determined in the determining step that the magnitude of the photocurrent exceeds the specific threshold, control so that the avalanche photodiode bias voltage decreases, and, when it is determined in the determining step that the magnitude of the photocurrent is less than or equal to the specific threshold, performing control so that the avalanche photodiode bias voltage becomes a constant high voltage.

5. A method of receiving light utilizing an avalanche photodiode, comprising:
applying a bias voltage to the avalanche photodiode;
monitoring a photocurrent flowing through the avalanche diode; and
controlling the bias voltage, by decreasing the bias voltage when the magnitude of the photocurrent exceeds a specific threshold, and by keeping the bias voltage constant when the magnitude of the photocurrent is less than or equal to the specific threshold.

6. The method according to claim 5, wherein the specific threshold of the photocurrent corresponds to a dynamic range of a pre-amplifier disposed in series to the avalanche photodiode and configured to amplify the photocurrent.

7. The method according to claim 5, further comprising:
monitoring the bias voltage; and
calculating an optical input power monitor value of the avalanche photodiode, wherein,
when the photocurrent exceeds the specific threshold, the operation of calculating the optical input power monitor value of the avalanche photodiode is performed based on the monitored bias voltage, and,
when the photocurrent is less than or equal to the specific threshold, the operation of calculating the optical input power monitor value of the avalanche photodiode is performed based on the magnitude of the photocurrent.
